(19) United States
(12) Patent Application Publication
(10) Pub. No.: US 2009/0114408 A1
(43) Pub. Date: May 7, 2009

(54) Method and apparatus for vertical preloading using containers for fluid

(76) Inventors: Craig Roberts, Vernon (CA); Lloyd Roberts, Vernon (CA); Elizabeth Jean Robert, Vernon (CA)

Correspondence Address: Antony C. Edwards, P.O. Box 26020, Westbank, BC, V4T 2G3, CA

(21) Appl. No.: 12/289,661

(22) Filed: Oct. 31, 2008

Related U.S. Application Data
(60) Provisional application No. 60/996,200, filed on Nov. 6, 2007.

(30) Foreign Application Priority Data
Nov. 8, 2007 (CA) 2,609,968

(51) Int. Cl. A01B 35/20

(52) U.S. Cl. 172/611

(57) ABSTRACT

The present invention is an apparatus for compacting ground using fluids stored in containers placed on the ground. The fluid containers may include a closely packed array of vertically aligned tubes arranged parallel to one another. Their base ends may be sealed and rest on the ground surface to be compacted. Their opposite upper ends may be either open or have a form of removable apertured lid or cap thereon to assist in filling of fluid into the containers. The closely packed array of tubes may be interlocked to one another for support and stability.

### CROSS REFERENCE TO RELATED APPLICATIONS

This application claims priority from U.S. Provisional Patent Application No. 60/996,200 filed Nov. 6, 2007 entitled Method and Apparatus for Vertical Preloading Using Containers for Fluid, and Canadian Patent Application No. 2,609,968 filed Nov. 8, 2007 entitled Method and Apparatus for Vertical Preloading Using Containers for Fluid.

### FIELD OF THE INVENTION

This invention relates to the vertical preloading by gravity of soils and the like and in particular to a method and apparatus for the vertical preloading using containers for fluids.

### BACKGROUND OF THE INVENTION

It is known in the art of geotechnical engineering to improve the foundation afforded by a soil mass or the like by the static preloading of that substrate by the weight of sand piles constructed on top of the substrate. Many other forms of ground compaction exist in the prior art however the use of sand piles is perhaps the most simple. There is some question whether the use of sand piles for compacting the ground is cost effective in that, depending on the type of soil being compacted, lesser or greater volumes of sand are required which must usually be trucked into place and subsequently removed. The cost of this procedure for lose or swampy ground requiring greater volumes of sand can be prohibitive. Further, it is often necessary to construct retaining walls around the worksite, or at least along one or more sides of the worksite adjacent existing building structures so as to contain the sand piles from bearing against the adjacent sidewalls of the existing structures.

It is an object of the present invention to alleviate some of the costs associated with the use of static sand pile ground compaction by the use of fluid containers to provide, when filled with fluid, the necessary weight to compact the ground substrate beneath the containers and further to provide for differential settling and compaction.

### SUMMARY OF THE INVENTION

The present invention is an apparatus for compacting ground using fluids stored in containers placed on the ground. In one embodiment of the invention, the fluid containers include a closely packed array of vertically aligned hollow vessels such as for example tubes arranged parallel to one another with their base ends sealed and resting on the ground surface to be compacted and their opposite upper ends either open or having a form of removable apertured lid or cap thereon to assist in filling of fluid into the containers.

In a preferred embodiment, the closely packed array of tubes are interlocked to one another for support and stability. The interlocking may include releasable interlocking projections on one tube interlocking with matching recesses on another tube, or may include clips or clamps extending between adjacent tubes to clamp one to the other, or may include straps extending around two or more adjacent tubes, or a combination of these or other releasable interlocking means. Preferably, the releasable interlocking means provide for differential vertical translation between adjacent tubes so as to accommodate differential rates of settling of the underlying ground. For example, an interlocking tongue and groove arrangement or pin and aperture arrangement between adjacent tubes would allow a first tube in an adjacent pair of tubes to slide vertically relative to the next adjacent tube to which it is interlocked. Thus an array of such closely packed tubes may each translate vertically relative to adjacent tubes in the array thereby providing force concentration in softer areas without compromising stability and support between tubes in the array.

In one embodiment, each of the tubes in the array is modular and may be constructed of relatively shorter lengths of tubing, whether or not of conventional diameter or of larger diameter than conventionally available. The interlocking modular sections of tubing forming a single elongate tube in the array, may interlock in such a way that an upper end of each section is formed with a lid having an aperture therethrough so that only the upper-most end of the upper-most section need be capped so as to releasably plug the aperture once the fluid has been poured or otherwise injected into the upper-most section. The fluid then flows through the open apertures at the upper ends of each of the sections until all of the sections from top to bottom in the tube are filled with fluid. Fluid may be removed once compaction is complete either by pumping or siphoning of the fluid from the upper-most ends of each tube, or by draining the fluid from drainage apertures formed in the lower sidewalls of each tube or each modular section. Each of the tubes may be interlinked by a network of hoses or the like so that filling of all of the tubes in the array may be accomplished from a single source and so that draining of the tubes may be accomplished by draining through a single end of an outlet hose from the network.

In an alternative embodiment, the fluid container may be, instead of an array of vertically aligned hollow tubes, a single bladder or plurality of adjacent bladders which may be filled with fluid such as water to accomplish ground compaction instead of using sand.

### BRIEF DESCRIPTION OF THE DRAWINGS

FIG. 1 is, in perspective view, a closely packed array of vertically aligned fluid containers for preloading according to one aspect of the present invention.

FIG. 2 is, in exploded view, one of the fluid containers of FIG. 1.

FIG. 3 is, in non exploded view, the fluid container of FIG. 2.

FIG. 4 is, in exploded lower perspective view, the fluid container of FIG. 2.

FIG. 5a is the fluid container of FIG. 3 with a lid mounted on the top thereof.

FIG. 5b is the fluid container of FIG. 5a with the lid partially removed.

FIG. 6 is, in partially cut away enlarged perspective view, the lower ends of two fluid containers from the array of FIG. 1 with the vertically slidable fitting mounted therebetween.

FIG. 7 is, in further enlarged partially cut away front elevation view, the vertically slidable fitting of FIG. 6.

### DETAILED DESCRIPTION OF EMBODIMENTS OF THE INVENTION

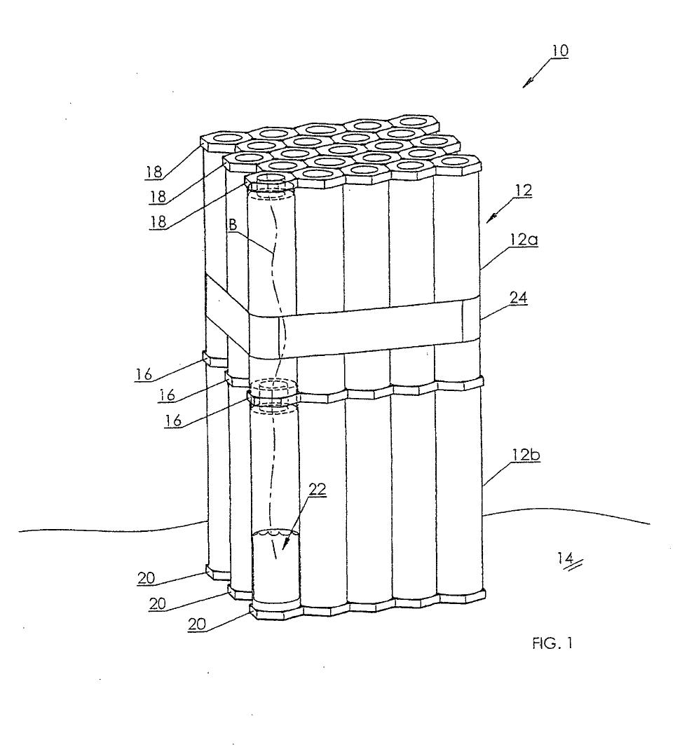

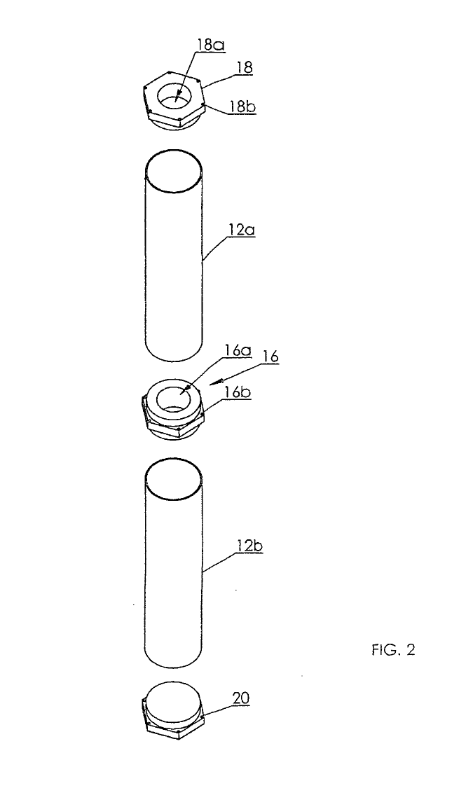

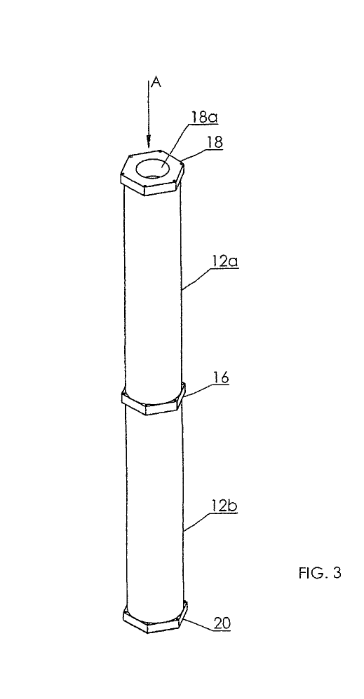

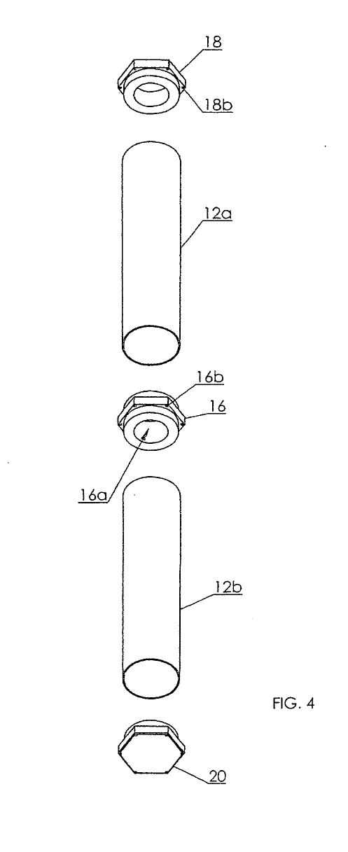

As seen in FIG. 1, a closely packed array 10 of tubes 12 rests under the force of gravity on ground surface 14. Although array 10 is shown as a relatively small bundle of tubes 12, it is understood that this is merely representative, and that the invention is not so limited, it being further understood, that a plurality of bundles of tubes 12 or just a single much larger array 10 may be used to employ the fluid containers for compaction according to the present invention.

Thus referring to the representative bundle of tubes 12, forming array 10, each individual tube 12 in the example illustrated is formed modularly of an upper tubular section 12a and a lower tubular section 12b arranged end-to-end in fluid communication therebetween through apertures 16a in interlocking collars 16. Interlocking collars 16 form a fluid communicating joint between the upper pipe section 12a and the lower pipe section 12b.

It is further understood that the invention is not necessarily limited to either module tubes 12 or necessarily to tubes 12 formed of cylindrical pipes, the present invention explicitly extending to tubes or pipes having cross sections other than circular, so long as they are hollow and capable of being filled with fluid and holding fluid within the hollow cavity thereof.

Thus, fluid is poured in through top cap 18 in direction A and flows downwardly for example along flow path B shown in dotted outline in FIG. 1 along the hollow cavity within firstly upper pipe section 12a, and into lower pipe section 12b via aperture 16a in collar 16. The lowermost end of lower pipe section 12b is sealed by base cap 20 mounted on the lowermost end thereof. Fluid such as water thus accumulates in firstly lower pipe section 12b and subsequently in upper pipe section 12a until the entire hollow cavity of tube 12 is full.

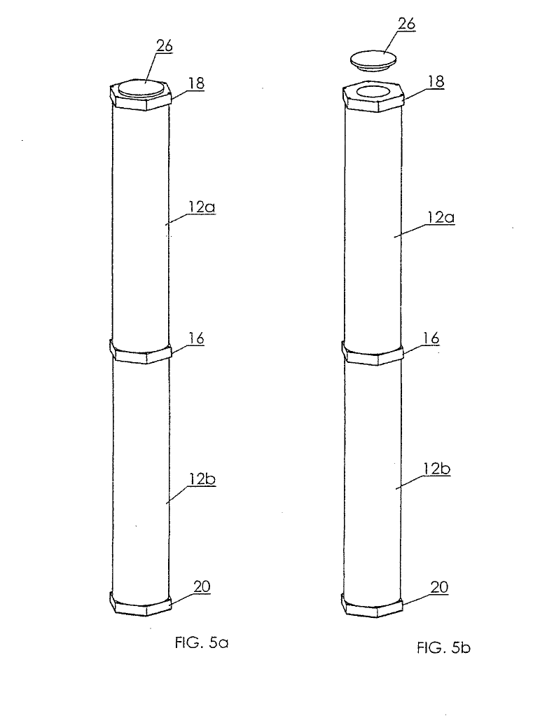

Thus depending on the density of fluid 22 in tubes 12, for example approximately 62.4 pounds per cubic foot of water, each individual tube 12, when filled, acts as an individual vertically aligned pile compressing vertically downwardly onto the corresponding patch of ground surface 14 therebeneath. As seen in FIGS. 5a and 5b, the filling aperture 18a in top cap 18 may be releasably sealed for example by the use of a resilient or other lid or stopper 26.

Array 10 of tubes 12 may be bundled together for example by the use of one or more straps 24 or other bundling or wrapping means which provide assistance in maintaining tubes 12 in their vertically adjacent array 10 while allowing for at least a small amount of vertical slippage, that is, vertical relative translation of one tube 12 relative to adjacent tubes 12 to provide for different rates of compaction of the ground underneath ground surface 14.

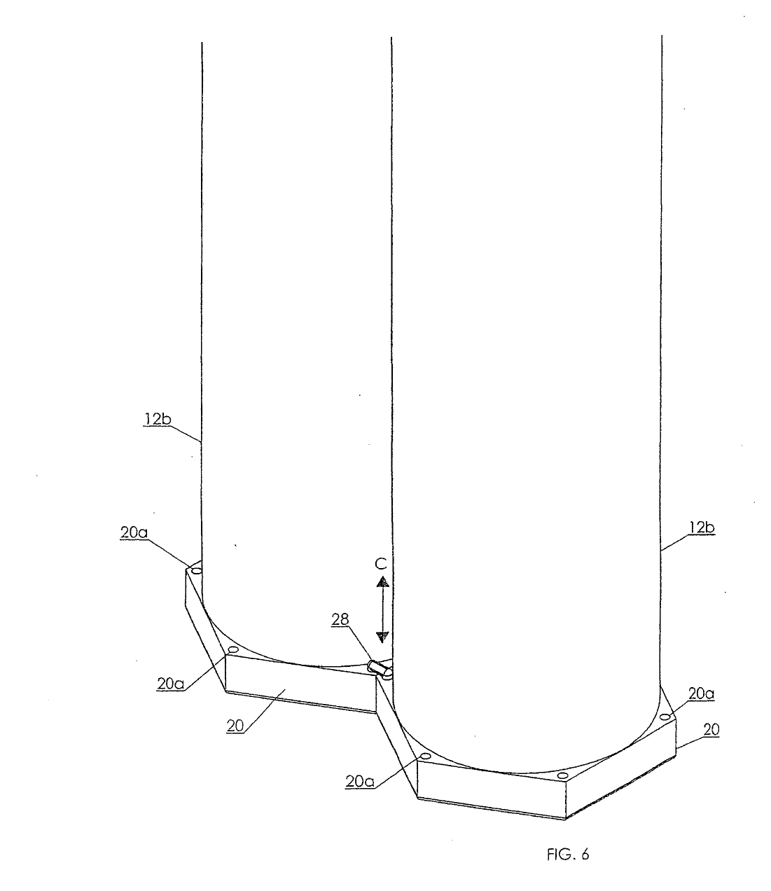

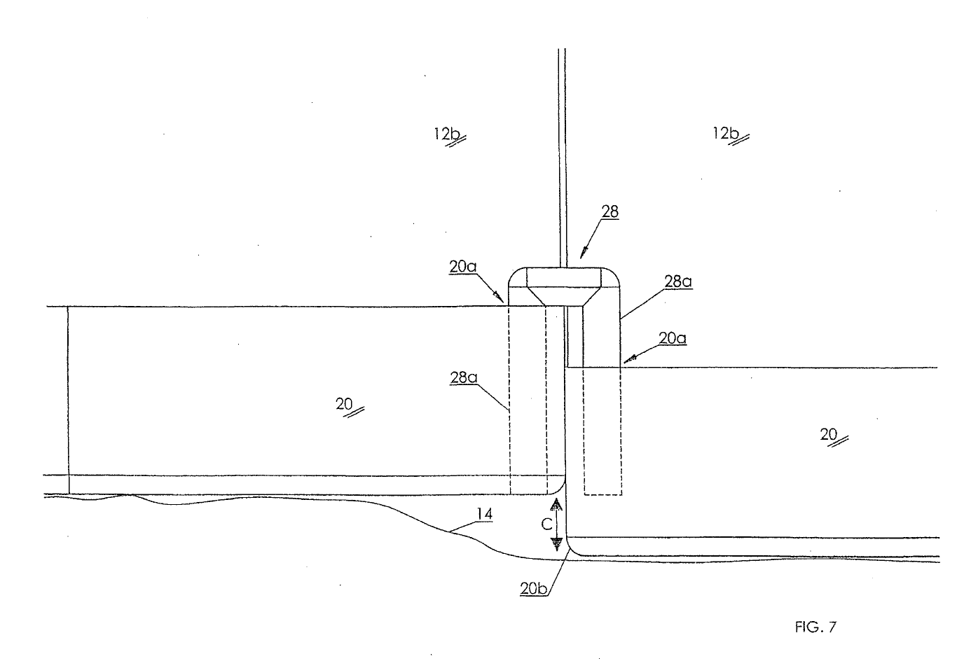

In a further embodiment of the present invention, a further releasable interlocking means such as seen in FIGS. 6 and 7 may be employed independently of, or in conjunction with, for example strap 24. Thus as seen in FIG. 6 base caps 20 may be hexagonal in horizontal cross section so as to mate surfaces of the hexagonal cap flush against one another when tubes 12 are closely packed in array 10. Similarly, collars 16 and top caps 18 may have identical hexagonal cross sections so that, like base caps 20, when tubes 12 are closely packed in array 10, adjacent tubes 12 mate one against the other by flush mating of corresponding surfaces of either collar 16 or top caps 18 one against the other. Preferably the hexagonal caps and collars are sufficiently thick so as to allow at least a small amount of relative differential movement in direction C as seen in FIG. 7 relative to one another without the flush mounted surfaces of adjacent collars and caps sliding entirely past one another. Thus U-shaped pin 28 has vertically depending parallel legs 28a which insert snugly downwardly into corresponding apertures 20a, 16b, and 18b formed in, respectively, base cap 20, collar 16, and top cap 18. The bottom lowermost edges of base cap 20 may have bevels 20b to assist in sliding tubes 12 over for example a six inch bed of sand which has previously been laid down onto ground surface 14.

In an alternative embodiment, a vibratory unit (not shown) may be inserted down through the hollow cavity of tubes 12 to assist in the compaction of the ground surface 14.

What is claimed is:

1. An apparatus for compacting ground comprising a closely packed array of vertically aligned water tight hollow vessels arranged parallel to one another, each hollow vessel of said array having a sealed base end adapted for resting on a ground surface to be compacted, said each hollow vessel having an opposite upper end adapted to assist in filling of fluid into said each hollow vessel.

2. The apparatus of claim 1 wherein each said hollow vessels of said array are all of substantially the same volumetric size and wherein each said base end of said hollow vessels are substantially of the same size in horizontal cross-section.

3. The apparatus claim 1 wherein said hollow vessels of said array are adapted to be interlocked to one another for support and stability of said array.

4. The application of claim 3 wherein said hollow vessels of said array are tubes.

5. The application of claim 4 where in said tubes interlock to one another by interlocking means on one tube interlocking with mating interlocking means on another adjacent tube.

6. The apparatus of claim 5 wherein said interlocking means is chosen from the group including: interlocking projections mating with matching recesses, clips, clamps, straps, wherein said interlocking means extend between adjacent said tubes to interlock one to the other.

7. The apparatus of claim 6 wherein said interlocking means are adapted to provide for differential vertical translation between adjacent said tubes so as to accommodate different rates of settling of the underlying ground being compacted.

8. The apparatus of claim 7 wherein said interlocking means includes an interlocking tongue and grove arrangement between adjacent said tubes so as to allow a first tube in an adjacent pair of said tubes to slide vertically relative to the next adjacent said tube to which said first tube is interlocked, wherein said tubes within said array are each, adapted to translate vertically relative to adjacent said tubes in said array thereby providing force concentration by corresponding to each said tube of the ground being compacted footprints in softer areas

9. The apparatus of claim 8 wherein each said tube in said array is a modular tube, and is constructed of lengths of tubing joined together end-to-end, and where in said lengths are the interlocking modular sections of tubing forming a single elongated.

10. The apparatus of claim 9 wherein each said tube includes a lid having an aperture therethrough, for filling therethrough of fluid into said tube.

11. The apparatus of claim 10 wherein each said modular tube includes end-to-end modular tubes sections and wherein each said section includes a lid having an aperture wherein only an upper-most end of an upper-most said section includes a cap so as to releasably plug the corresponding upper-most said aperture, wherein fluid that has entered through said upper-most aperture into said upper-most section flows through said apertures at the upper ends of adjacent said end-to-end sections until all of the sections from top to bottom in said modular tube are filled with the fluid.

12. The apparatus of claim 8 wherein each said modular tubes includes at least one drainage aperture formed in lower sidewalls thereof

13. The apparatus of claim 8 wherein each said tube in said array is interlinked by a network of fluid conduits so that filling of one of said tubes substantially fills all of said tubes in said array from a single fluid source.
